(19) United States
(12) Patent Application Publication
(10) Pub. No.: US 2014/0064500 A1
(43) Pub. Date: Mar. 6, 2014

(54) Automatic Power Adjusting Headphones

(71) Applicant: Monster, Las Vegas, NV (US)

(72) Inventor: Noel Lee, Las Vegas, NV (US)

(21) Appl. No.: 13/975,309

(22) Filed: Aug. 24, 2013

Related U.S. Application Data
(60) Provisional application No. 61/695,273, filed on Aug. 30, 2012.

(51) Int. Cl. H04R 3/00

(52) U.S. Cl. CPC H04R 3/00
USPC 381/58

(57) ABSTRACT

The invention relates to a device, system, and method for a headphone that detects whether the device is in use and either automatically powers up the device when in use, or automatically powers down the device when not in use, or both.

### CROSS-REFERENCE

This application claims priority to U.S. Provisional Patent Application Ser. No. 61/695,273, “Automatic Power Adjusting Headphones,” filed Aug. 30, 2012, which application is incorporated by referenced herein in its entirety.

### BACKGROUND

a. Field of the Invention

The present invention is generally related to a power saving system and method related to headphones, and in particular to reducing/eliminating power usage when the headphones are not in use.

a. Discussion of the Related Art

Modern headphones have gotten very sophisticated with numerous electronic enhancements. Those enhancements include features like Bluetooth or Wi-Fi connectivity, active noise cancelling, active equalization and other possible electronic features. All of these features require power. Battery power is usually required since the devices are mobile in nature and not necessarily able to get power from external sources. Getting long life from the batteries is important to meet expectations of usability of the devices. If for example the batteries are drained before the end of a long flight and the active noise cancellation no longer functions, the user's expectation of the device has not been met.

Extending battery life requires strategies to reduce or eliminate unnecessary power draw when not needed. These devices when added to the headphone can substantially extend the battery life and prevent unnecessary power draw. The requirements are to shut down services in the headphone, like noise cancellation and Bluetooth connections, when not in use, for example when the headphone is not on the users head.

Further, headphone users may forget to power down the headphones when they're removed. Therefore there is a need for a method, device, and/or system to automatically power down some or all of the powered elements of a headphone when not in use. One single method may not be optimal for maximum power saving. There are limitations to each method described, so a combination of them may be required to maximize battery life.

### SUMMARY OF THE INVENTION

A combination of switches and sensors are used to enable power to the device, and to engage or disengage when the headphone is over the user's ears. To save battery life, the unit will switch off when it detects that the headphones are not in active use by the user. The device can also work in the reverse and turn on when the consumer puts it on. The system/device also works when paired with a media device (e.g. bluetooth) if the headphone and media source are wirelessly enabled.

Other techniques that can be used to detect whether the headphones are in use include monitoring whether or not content is playing into the headphones, such as detecting whether the headphones are receiving input from a device. It should be noted that in this case a lack of source content preferably does not turn off any active noise cancellation that was in use, since a user may simply wish to wear the headphones to eliminate ambient sound.

Still other methods of detecting whether the headphones are in use include sensing the positioning of the headphone, including whether the arm(s) of the headphone are extended, whether the arm(s) of the headphone are unfolded, and whether the headphone is on a person's head by the expansion of the headband (measured expansion). For instance, a user may wish to have the headphone around their neck while powered down.

Other features of the invention may include the following:
If the unit is Active and the user removes the unit from his/her head the system will go into standby mode after a short period of time (e.g. after 2 seconds via a timer);
When placed back on the user's head, the systems goes back to an ON state within 1-2 seconds;
If the unit is OFF, the headphone will still function in passive mode;
When the hinge unfolds, there are switches underneath the hinge that are engaged which turn on the headphone;
Ear cups detect changes in capacitance (via a user's ears) when the ear cups are on or around a human ear, and powers up the device;
The buttons for play/pause, volume up, and volume down work in either Bluetooth mode or wired mode, even without power; and
The device turns off the wireless function, like Bluetooth, within the headphone when a wired connection is being used. For instance, a switch on the wired headphone jack (such as a 3.5 pin shown in the drawings) with a built in switch could automatically turn off the Bluetooth function when the jack is engaged. This function would reduce power consumption without negatively affecting the performance of the device. When the wired connection is made it will automatically turn off the wireless function. The device could also automatically turn off the wireless function when in an airplane when wired connection is made, and/or where wireless functionality is not permitted.

### BRIEF DESCRIPTION OF THE DRAWINGS

FIG. 1 shows a front view of an embodiment of the invention.

FIG. 2 shows a front view of an embodiment of the invention.

FIG. 3 shows a perspective view of an embodiment of the invention.

FIG. 4 shows a front view of an embodiment of the invention.

FIG. 5 shows a front view of an embodiment of the invention.

FIG. 6 shows a front view of an embodiment of the invention.

FIG. 7 shows a schematic of various components that can be used in the system/device/method.

### DETAILED DESCRIPTION OF THE INVENTION

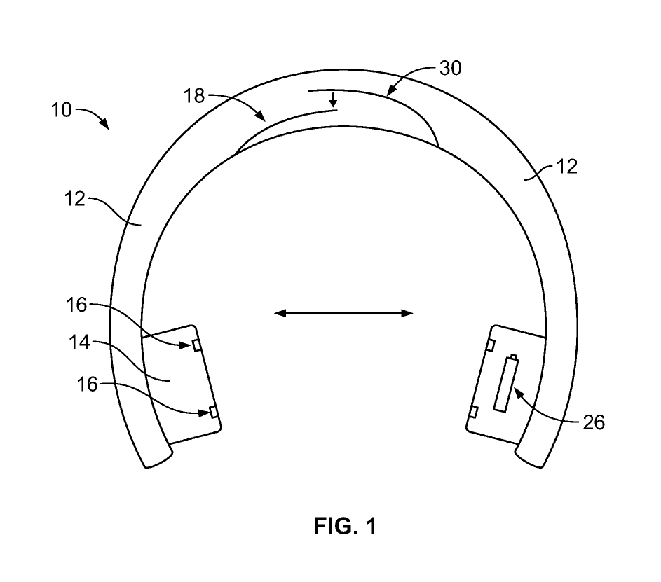

Referring to FIGS. 1-5, there are mechanical switches 18 coupled to hinges 28 that are part of a folding mechanism of the headband 12 that is used to make the device more energy efficient when not in use. These switches 18 are connected in series to the main battery 26, disconnecting it when the headphone is folded, or otherwise not in use. In a preferred embodiment, only the sensors and control system are powered up while in this low power state, drawing little power. A headphone 10 may be able to stay in this state for long periods of time without completely draining the battery. However, opening the headphone 10 does not ensure that it is on the user and ready to make use. In one embodiment, opening the headphone will put the headphones into an idle, low power, state until the sensors 16 sense that the headphone 10 is on the user.

The sensors 16 can use capacitive, thermal, pressure or conductive contact to determine whether they are in use, in different implementations. When the sensors 16 detect a wearer, they switch on the electronics and the system goes to full operation. When the headphone 10 is removed, the sensors 16 detect it and the system goes to a lower power state. In one embodiment, two sensors 16 in each ear cup 14 are used to ensure that each ear cup 14 is fully on the user's ear or head. The system will have fewer errors if all four sensors 16 (two in each earcup) are sensing the user before the system goes to full operation. This prevents false starts from manually picking up the headphones from one side for example. It is also possible to use motion sensing technologies (e.g. motion sensors) to determine that the headphone has been picked up and is on a wearer.

One embodiment of the invention senses the strain on the headband by detecting that the headphone is on the user. There may be situations where the headphone will be expected to function when not on the user as a form of “personal speaker” which can be implemented with switches that sense the orientation of the ear cups.

Also, detecting means such as switches 18 and/or sensors can be activated or deactivated via mechanical movement of the headphone hinges 28, such as when the hinges 28 are rotated or swiveled. The switch(s) can be located in the rotatable hinge(s). In one embodiment, rotating one side of the headphone 12 (e.g. swiveling one earphone away from the user's ear while the second earphone is still covering the user's other ear) will power down the unused side (or channel) of the headphones.

FIG. 1 shows a front view of an embodiment of the invention, where a switch 18, located in this example in the headband 12, is shown with an electrically conductive component, as well as an actuator 30. The headphone 10 is shown here to represent the device while not in use. The headband 12 is in the ‘upstretched’ position and preferably in the powered down state or mode. The switch 18 and the actuator 30 are not in contact, which causes the device to power down. As the headphones 10 are placed on the head of a user, the headband is stretched outward, which causes the actuator 30 to make electrical contact with the switch 18 and power up the device.

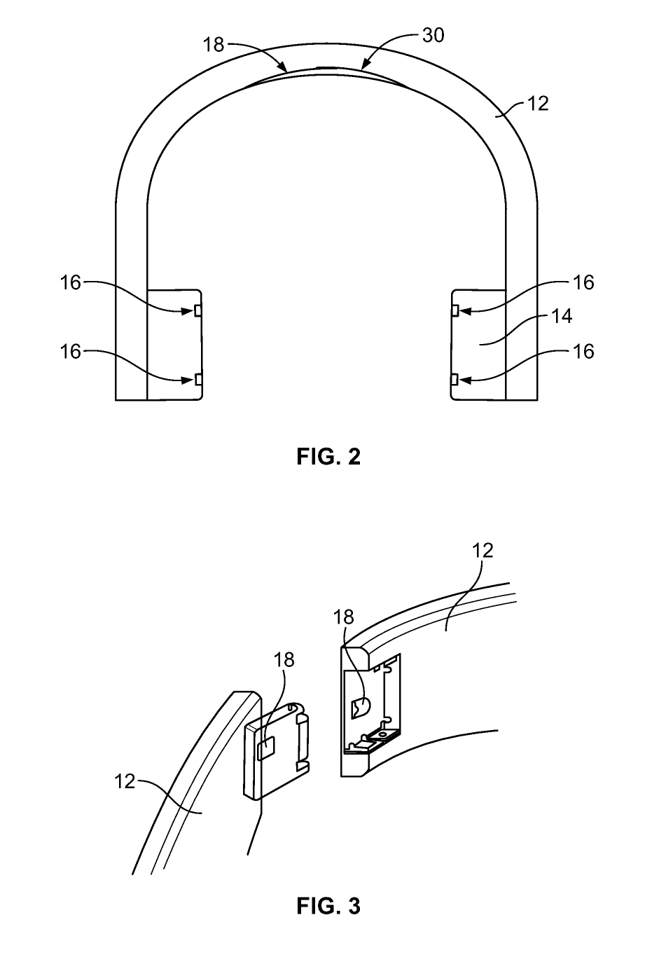

FIG. 2 shows a front view of the invention in the stretched position, as when on the head of a user. Here, the actuator 30 is in contact with the switch 18, which completes the electrical connection between the components. When the headband is extended to fit over a user's head, the curve of the headband changes, causing the switch to close (see FIGS. 1-6). A switch 16 (e.g. an electrical component that can break an electrical circuit, interrupting the current or diverting it from one conductor to another) can be used in this auto on/off system. The switch could be located in a variety of locations, but is preferably located in the headband portion to take advantage of the mechanical bending action associated with putting on and taking off the headphones.

In this application, a manually operated electromechanical switch could be used with one or more sets of electrical contacts, which are connected to an external circuit. Each set of contacts can be in one of two states: either “closed” meaning the contacts are touching and electricity can flow between them, or “open”, meaning the contacts are separated and the switch is nonconducting. The mechanism actuating the transition between these two states (open or closed) can be either a “toggle” (flip switch for continuous “on” or “off”) or “momentary” (push-for “on” or push-for “off”) type.

Automatically operated switches have been used to control the motions of machines, for example, to indicate that a garage door has reached its full open position or that a machine tool is in a position to accept another workpiece. A variety of switches may be operated by process variables such as pressure, temperature, flow, current, voltage, and force, acting as sensors in a process and used to automatically control the system. An ideal switch would have minimal rise time and fall time during state changes, and would change state without “bouncing” between on and off positions.

In some instances, such as when the headphones are being handled or moved, the headphones are not intended to be in use or powered up. To reduce the likelihood of unintentionally powering up the device, sensors 16 are preferably employed that determine whether the headphones 10 are on the head or ears of the user. A variety of different sensors can be used for this purpose.

Capacitive sensing is a technology based on capacitive coupling which takes human body capacitance as input. Capacitive sensing can be used in many different types of sensors, including those to detect and measure proximity, position or displacement, humidity, and acceleration. Capacitive sensing as a human interface device (HID) technology could also be used in this application. Capacitive touch sensors have been used in other devices such as laptop trackpads, digital audio players, computer displays, mobile phones, mobile devices, tablets and others. Capacitive sensors are versatile, reliable and robust, unique human-device interfaces that can provide cost reduction over mechanical switches.

Capacitive sensors detect anything that is conductive or has a dielectric different than that of air. Capacitive sensors are constructed from many different media, such as copper, indium tin oxide (ITO) and printed ink. Copper capacitive sensors can be implemented on standard FR4 PCBs as well as on flexible material. Size and spacing of the capacitive sensor are both very important to the sensor's performance. In addition to the size of the sensor, and its spacing relative to the ground plane, the type of ground plane used is very important. Since the parasitic capacitance of the sensor is related to the electric field's (e-field) path to ground, it is important to choose a ground plane that limits the concentration of e-field lines with no conductive object present.

Self or absolute capacitance could be used, where the object (such as an ear) loads the sensor or increases the parasitic capacitance to ground. Capacitance is typically measured indirectly, by using it to control the frequency of an oscillator, or to vary the level of coupling (or attenuation) of an AC signal. The design of a simple capacitance meter is often based on a relaxation oscillator. The capacitance to be sensed forms a portion of the oscillator's RC circuit or LC circuit. Another measurement technique is to apply a fixed-frequency AC-voltage signal across a capacitive divider.

Alternately, a strain gauge 24 located in or on the headband 12 can sense the bending of the headband. For instance, when a user puts the headphone on, the strain gauge senses the bending of the headband, and instructs the unit to power up.

A strain gauge 24 is a device used to measure the strain of an object, and takes advantage of the physical property of electrical conductance and its dependence on the conductor's geometry. When an electrical conductor is stretched within the limits of its elasticity such that it does not break or permanently deform, it will become narrower and longer, changes that increase its electrical resistance end-to-end. Conversely, when a conductor is compressed such that it does not buckle, it will broaden and shorten changes that decrease its electrical resistance end-to-end. From the measured electrical resistance of the strain gauge, the amount of applied stress may be inferred. A typical strain gauge arranges a long, thin conductive strip in a zigzag pattern of parallel lines such that a small amount of stress in the direction of the orientation of the parallel lines results in a multiplicatively larger strain over the effective length of the conductor—and hence a multiplicatively larger change in resistance—than would be observed with a single straight-line conductive wire.

Foil strain gauges can be incorporated into the invention as well. Different applications place different requirements on the gauge. In most cases the orientation of the strain gauge is significant. Strain gauges can be attached to the headband with glue. For long lasting installation epoxy glue is preferred. Usually epoxy glue requires high temperature curing (at about 80-100° C.). The preparation of the surface where the strain gauge is to be glued is of importance. The surface should be smoothed and de-oiled with solvents. The solvent traces should then be removed and the strain gauge should be glued immediately after this to avoid oxidation or pollution of the prepared area. If these steps are not followed the strain gauge binding to the surface may be unreliable, and unpredictable measurement errors may be generated.

Strain gauge based technology is utilized commonly in the manufacture of pressure sensors. The gauges used in pressure sensors themselves are commonly made from silicon, polysilicon, metal film, thick film, and bonded foil. Capacitive sensors in the headphones or headband could also be used in the automatic on/off system. The capacitive sensors could be located in a variety of locations, including in the headband, headphones, pads/cushions, or ear cups.

Similarly, other sensors in or on the device could be used as well, including but not limited to light (including infra-red), touch, heat, RF, motion, pressure, electro-sensing, inductive, moisture, or any other technology that senses a human wearing the headphone.

FIG. 3 shows a perspective view of an embodiment of the switch 18 in the headband 12. The two ends of the headband 12 are then coupled together, which also couples the switch 18 mechanism. The switch 18 can then be used to determine whether the headphones 10 are on a user's head.

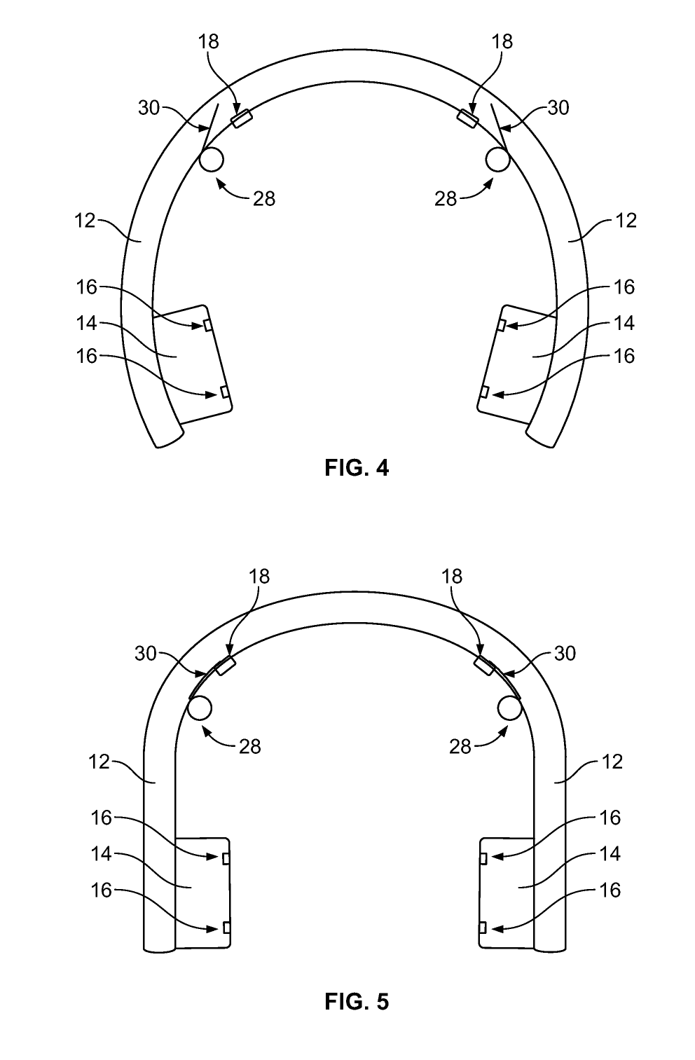

FIG. 4 shows a front view of an embodiment of the invention, wherein the headphones are not in use. In this condition, the headband 12 has a great arc and therefore the hinge 28 and actuator 30 are angled such that the actuator 30 is not in contact with the switch 18. As before, this causes the device to power down when not in use.

FIG. 5 shows a front view of FIG. 4, wherein the headphones are in use. In this condition, the headband 12 has been stretched outwardly to accommodate the user's head, which then causes the actuator(s) 30 to make contact with the switch(s) 18 and complete the circuit and power up the device.

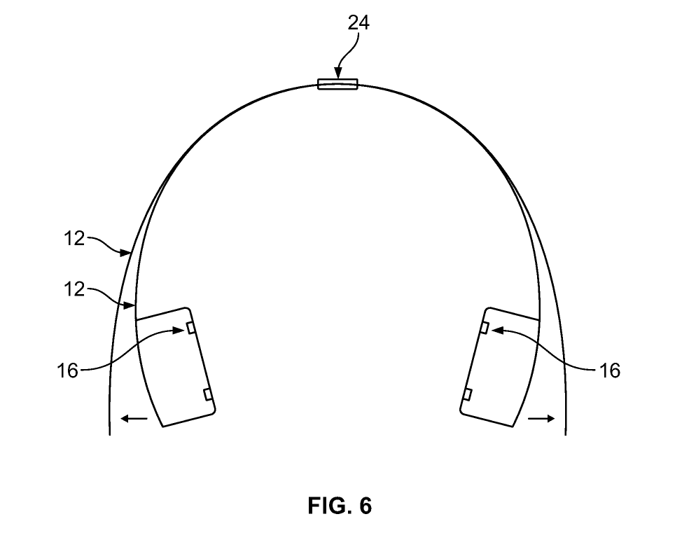

FIG. 6 is a front view of an embodiment of the invention that incorporates a strain gauge 24 in the headband 12. The headband is shown both in its upstretched and stretched configurations. As the headband is stretched outwardly, the strain gauge 24 detects the increased strain on the headband. Ideally, after the sensors 16 confirm the presence of the user's head between the ear cups 14, the system will power up.

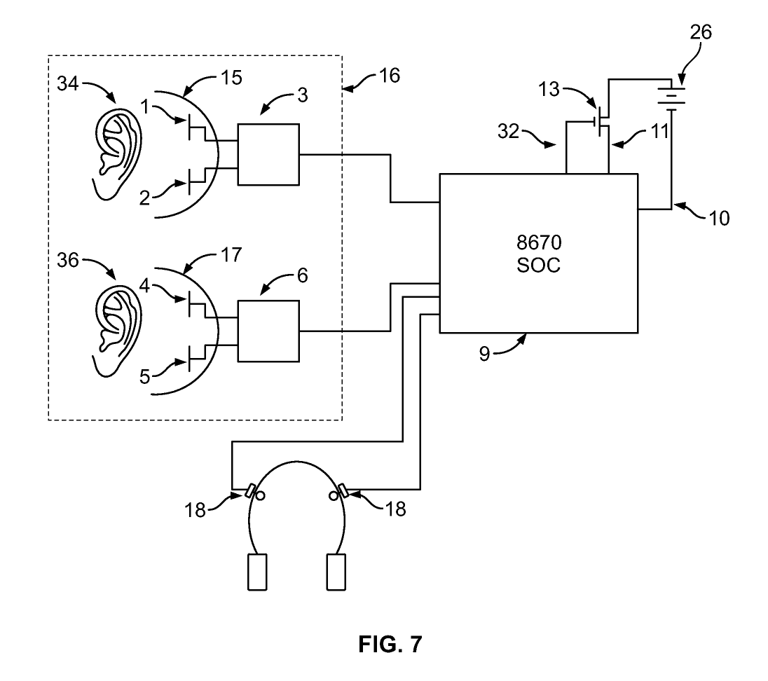

FIG. 7 shows a schematic of various components that can be used in the system/device/method. When the headphone is opened for use switches 18 are closed telling the System on a Chip (SOC, 9) that operates the device to power on. It then enables the primary power (Battery, 26) to provide main power via control signal (32) through switching device (transistor Control Switch, 13).

Once the main system has powered up, it waits for the Sensor MCUs (microcontroller units) 3, 6 to indicate that the sensor pads for each ear 34, 36 (1, 2 for the right ear and 4, 5 for the left ear) have enough capacitance from the presence of a human ear (34, 36) in the ear cup (15, 17). When the MCUs 3, 6 indicate that the ears are present, it powers the rest of the headphone system up and enables audio. A timeout, typically 15 seconds, prevents the system from powering down if the signals from the switches 18 or sensors 1, 2, 4, 5 are momentarily interrupted for any reason.

We claim:

1. An automatic power adjusting headphone assembly comprising electronic components that can be in a powered up or powered down state, comprising:
a. a battery;
b. a headband;
c. at least one ear cup attached to the headband;
d. an electrically conductive switch mechanism, located in the headband, that is activated when the headband is stretched in an outward direction;
e. wherein the switch mechanism, when activated, powers up the headphone; and
f. wherein the switch mechanism, when not activated, powers down the headphone.

2. The headphone of claim 1, further comprising:
a. At least one sensor means in at least one ear cup, wherein the sensor means detects whether the headphones are located on a human head;
b. Wherein the headphone automatically powers up when the switch mechanism is activated and the at least one sensor detects that the headphones are located on a human head; and
c. Wherein the headphone automatically powers down when the switch mechanism is not activated and the at least one sensor does not detect that the headphones are located on a human head.

3. The headphone of claim 1, wherein the switch mechanism comprises a hinge mechanism and an actuator mechanism.

4. The headphone of claim 2, wherein the sensor means comprises a light sensor.

5. The headphone of claim 2, wherein the sensor means comprises an infrared light sensor.

6. The headphone of claim 2, wherein the sensor means comprises a touch sensor.

7. The headphone of claim 2, wherein the sensor means comprise a heat sensor.

8. The headphone of claim 2, wherein the sensor means comprises a RF sensor.

9. The headphone of claim 2, wherein the sensor means comprises a motion sensor.

10. The headphone of claim 2, wherein the sensor means comprises a pressure sensor.

11. The headphone of claim 2, wherein the sensor means comprises an electro-sensing sensor.

12. The headphone of claim 2, wherein the sensor means comprises an inductive sensor.

13. The headphone of claim 2, wherein the sensor means comprises light sensor.

14. The headphone of claim 2, wherein the sensor means comprises a moisture sensor.

15. The headphone of claim 2, wherein the sensor means comprises strain gauge.
